(19) United States
(12) Patent Application Publication
(10) Pub. No.: US 2008/0029702 A1
(43) Pub. Date: Feb. 7, 2008

(54) METHOD AND APPARATUS FOR DETECTING METHANE GAS IN MINES

(76) Inventor: Wei Xu, Winchester, MA (US)

Correspondence Address: WEI XU, 11 BRADFORD RD., WINCHESTER, MA, 01890, US

(21) Appl. No.: 11/781,948

(22) Filed: Jul. 23, 2007

Related U.S. Application Data
(60) Provisional application No. 60/820,111, filed on Jul. 23, 2006.

(51) Int. Cl. G01N 21/31

(52) U.S. Cl. 250/338.5

(57) ABSTRACT

The present invention is a method and apparatus for remotely detecting methane gas in mines by laser remote sensing technologies. The apparatus has at least one light source emitting photons towards mine walls and at least one light detection device accepting photons reflected from mine walls. When methane gas presents at the optical path, these photons experience strong optical attenuation and indicate methane existence. The invention employs tunable laser spectroscopy technology to measure the concentration path length vectors. The invention further uses tomography algorithms to determine existence, concentration and distribution of methane gas from the measured concentration path length vectors. Explosions due to mix of methane mine gas with air can be prevented by sensing methane existence and minimizing its concentrations through methane drainage and ventilation.

### CROSS REFERENCES

Gruber T C Jr. and Grim L B, “Visualization of foreign gases in atmospheric air,” Proceeding of 11th International Symposium on Flow Visualization, University of Notre Dame, Notre Dame, Ind., USA, Aug. 9-12, 2004.
Iseki T, Tai H and Kimura K, “A portable remote methane sensor using a tunable diode laser,” Measurement of Science and Technology, volume 11, page 594-602, 2000.
Uehara K and Tai H, “Remote detection of methane with a 1.66 μm diode laser,” Applied Optics, volume. 31, page 809-814, 1992.
Wainner R T, Green B D, Allen M G, White M A, Stafford-Evans J and Naper R, “Handheld, battery-powered near-IR TDL sensor for stand-off detection of gas and vapour plumes,” Applied Physics B, volume 75, page 249-254, 2002.
Verhoeven D, “Limited-data computer tomography algorithms for the physical sciences,” Applied Optics, volume 32, page 3736-3754, 1993.

### FIELD OF THE INVENTION

The present invention generally relates to the field of detection of methane gas in mines by laser remote sensing technologies. More specifically, the present invention, in an exemplary embodiment, relates to remote detection and measurement of existence, distribution, and concentration of methane gas in mines by means of tunable laser spectroscopy technology and tomography algorithms.

### BACKGROUND OF THE INVENTION

Methane gas is one of the key reasons for mine explosion. When methane concentration in air ranges from 5% to 16%, explosions could happen in the presence of an ignition source. Explosions can be prevented by detecting methane existence and minimizing its concentrations through methane drainage and ventilation. Various types of methane detectors have been used in mines. However, they have common drawbacks—they are point sensors and they can only detect methane locally. In mines, methane gas may exist inhomogeneously with different concentrations. The point sensors cannot detect the overall methane distribution and may give misleading readings. Moreover, methane gas may appear at difficult-to-access locations and unexpected locations, where the point sensors are not installed.

This invention reveals the method and apparatus of remotely detecting methane mine gas utilizing the principle of strong optical absorption of the gas at some specific wavelengths and concentration mapping tomography algorithms. Every location of the entire mines can be rapidly and effectively inspected for methane existence and concentration distribution by the apparatus presented in the invention.

### SUMMARY OF THE INVENTION

A method and apparatus for remotely detecting methane gas in mines is disclosed, utilizing readily available laser remote sensing technologies. The apparatus launches a laser beam towards mine walls. The wavelength of the laser beam is selected at one of methane optical absorption peaks. The reflected photons are then collected by the apparatus. If methane gas exists between the apparatus and mine walls, the photons have strong optical loss, which indicates methane existence. The invention employs tunable laser spectroscopy technology to measure the concentration path length vector. The invention further uses tomography algorithms to determine existence, concentration and distribution map of methane gas from the measured concentration path length vectors. Mine explosions can be prevented by rapidly and effectively alarming dangerous concentration of methane gas.

### BRIEF DESCRIPTION OF THE DRAWINGS

FIG. 1 is a schematic representation of an apparatus of detecting methane mine gas using tunable laser spectroscope technology.

FIG. 2 is a schematic representation of an apparatus scanning the laser beam to measure the concentration path length vector as a function of azimuth θ.

### DETAILED DESCRIPTION OF THE INVENTION

Methane gas strongly absorbs photons at some specific wavelengths such as 3.4 micron and 1.65 micron. When photons at these absorption wavelengths pass through the methane gas, the optical power is highly attenuated. At wavelengths slightly different than these optical absorption peaks, there is essentially no optical absorption. Based on this optical absorption phenomenon, methane gas can be remotely detected by tunable laser spectroscopy technology and the gas concentration spatial distribution can further be mapped by tomography algorithms.

Laser spectroscopy technology utilizes a tunable laser source, whose wavelength has a very narrow spectral linewidth (a few hundred kHz to a few thousand kHz) and whose wavelength can be changed or tuned. An example of a tunable laser source is InGaAs distributed feedback laser diode. The diode emits a narrow linewidth laser with central wavelength at 1.65˜1.66 micron. The wavelength of the laser can be tuned by changing the temperature of the diode. Remote detection of methane using a 1.66 micron laser diode was first studied by Uehara and Tai (Uehara 1992). More recently, Iseki et al. (Iseki 2000) and Wainner et al. (Wainner 2002) reported portable handheld remote methane sensors independently. However, both of the remote methane sensors were employed to detect methane emission and existence from natural gas leaks in pipelines or garbage landfills. However, no localized methane gas concentration and spatial distribution were measured.

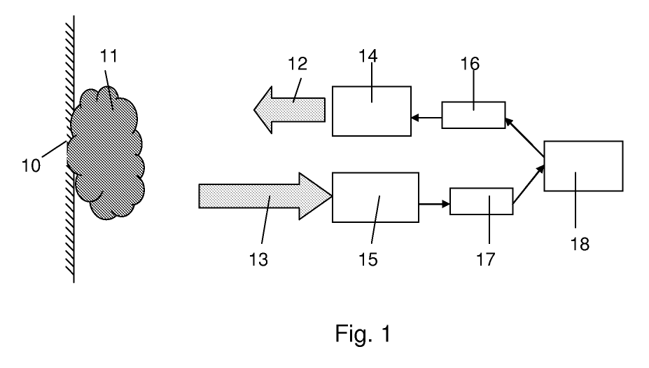

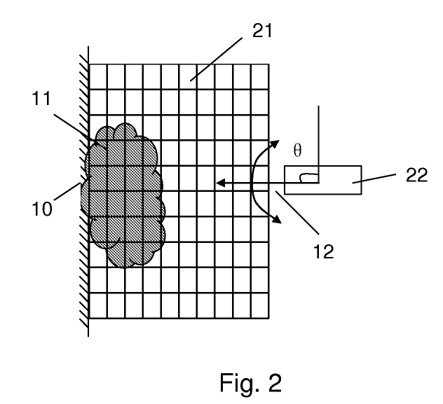

The present invention applies tunable laser spectroscopy technology to remotely detect existence and concentration of methane gas in mines as shown in FIG. 1. By scanning the laser beam emitted from said methane detection apparatus 22 as shown in FIG. 2, location and concentration spatial distribution of the methane gas in mines can be mapped through tomography algorithms.

Said tunable laser source 16 emits a laser beam 12 through optical collimating components 14 towards said mine wall 10. Said laser beam 12 is reflected from said mine wall 10 and passes through said methane gas 11 if it exists. Said reflected laser beam 13 is directed toward said photo detector 17 via photon collecting and focusing optical components 15. Operatively in connection with said tunable laser source 16 and said photo detector 17, said signal process and control unit 18 modulates the wavelength of said laser source 16 across one of the methane gas's absorption peaks and measures optical absorption of said reflected laser beam 13. The concentration of said methane gas 11 integrated over said laser beam's path length can be then deduced. The measured concentration path length is usually expressed in units of atm-m.

Fast tuning capability of said laser source 16 is exploited to rapidly and repeatedly tune the laser wavelength across the selected gas absorption peak. While this wavelength tuning occurs, said reflected laser beam 13 through said methane gas 11 is monitored with said photo detector 17. The transmission of laser beam through an absorbing gas can be expressed by the Lambert-Beer law as
I_{d}(ν)=AIₒ(ν) exp[α(ν)·2CL(θ)] (1)
where I_{d}(ν) is the power of said laser beam 13 received by said photo detector 17 (in watts) as a function of wave number ν (the inverse of wavelength), Iₒ(ν) is the initial power of said laser beam 12 (in watts) as a function of wave number ν, A is the collection efficiency (the ratio of the received laser power to the initial laser power in the absence of the methane gas), α(ν) is the absorption coefficient (in atm⁻¹ m⁻¹) of methane at the laser wave number of ν, and CL(θ) is the methane concentration path length vector (in atm-m) integrated from said detection apparatus 22 to said mine wall 10 at azimuth θ by scanning said laser beam 12. The L part of CL(θ) is the range (in meters) from said detection apparatus to said mine wall 10. The C part of CL(θ) is the average concentration along the range L. Since the laser beam is received after round-trip propagation between said detection apparatus and said mine wall 10, the range-integrated concentration path length CL(θ) is doubled in equation (1).

The concentration path length vector CL(θ), as a function of azimuth θ, can then be calculated from Equation (1) as
CL(θ)=−Ln(I_{d}(ν)/AIₒ(ν))/2α(ν) (2)
Said signal process and control unit 18 processes CL(θ) vector results with tomography algorithms to produce location, size and concentration map of said methane gas 11. One of exemplary tomography algorithms is described as follows (Gruber 2004, Verhoeven 1993). Firstly, the space between said detection apparatus 22 and said mine wall 10 is divided into said grid cells 21, as shown in FIG. 2. Next, said grid cells containing methane gas are determined by identifying the intersection of the non-zero CL(θ) vectors and the grid cells. A binary methane gas map can be created with the results of judging the grid cells with zero and non-zero concentrations. The binary map shows the size and location of the methane gas. Finally, the binary methane gas map data and the CL(θ) vectors are used as the input data for the algebraic reconstruction technique tomography algorithm. The algorithm generates an average gas concentration for each grid cell. The smaller the grid cells are, the more accurate the gas concentration at each cell can be obtained. The methane gas concentration map is then plotted from the grid cell results. Thus, the existence,

What is claimed is:

1. A method and apparatus for remotely detecting existence, concentration and distribution of methane gas in mines, comprising:
at least one tunable laser source, wherein the wavelength of said source can be tuned across one of methane optical absorption peaks, and photons of the laser source are emitted towards mine walls;
at least one light detection device, wherein photons reflected from mine walls are collected and converted into electronic signals;
at least one signal process and control unit, operatively in connection with said optical source and said light detection device, for analyzing said signals with tunable laser spectroscopy technology and tomography algorithms, and determining existence, concentration and distribution of said methane mine gas.

2. Said tunable laser source of claim 1 is a semiconductor laser diode or a fiber laser, or a solid state laser, or a gas laser.

3. The wavelength of said tunable laser source of claim 2 is tuned by changing the temperature or strain of the lasing cavity of said laser source.

4. Said tunable laser spectroscopy technology of claim 1 is based on wavelength modulation or frequency modulation.

5. Said tomography algorithm of claim 1 is based on algebraic reconstruction technique.

6. Said apparatus of claim 1 is carried by a person to scan the spaces of mines and map concentration distribution of methane gas.

7. Said apparatus of claim 1 is mounted on an object, for example, a machine, to scan the spaces of mines and map concentration distribution of methane gas.

8. Said apparatus of claim 1 is installed at certain locations of mines to scan the spaces of mines and map concentration distribution of methane gas.
